(19) United States
(12) Patent Application Publication
(10) Pub. No.: US 2004/0014628 A1
(43) Pub. Date: Jan. 22, 2004

(54) Solvent stripper for removing polymer residue and method of using the same

(76) Inventors: Ching-Ping Wu, Taipei (TW); H. W. Lee, Feng-Shan City (TW); Tsung-Yu Hung, HsinChu (TW); Nan-Tzu Lian, Hsinchu (TW); Hsin-Cheng Liu, Hsinchu (TW)

Correspondence Address: RABIN & Berdo, PC, 1101 14TH STREET, NW, SUITE 500, WASHINGTON, DC, 20005, US

(21) Appl. No.: 10/199,055

(22) Filed: Jul. 22, 2002

(51) Int. Cl. B08B 3/08

(52) U.S. Cl. 510/405; 134/42; 510/175

(57) ABSTRACT

A composition suitable for removing a polymer residue on a substrate in post metal solvent strip process substantially comprises water, alkanolamine and a sugar alcohol, and the amount of water is improved to about 20%. To remove the polymer residue, the composition of the invention is applied on a substrate for about 5 min to 15 min at a temperature ranged from about 60° C. to 70° C. The lifetime of the composition is greatly extended from 12 hours to 48 hours by increasing the amount of water from 15% to 20%.

### BACKGROUND OF THE INVENTION

1. Field of the Invention

The invention relates in general to a stripper for removing polymer residue such as sidewall polymer fence, and more particularly to the non-HDA (Hydroxylamine) solvent containing optimal amounts of water to completely remove sidewall polymer fence without attacking the metallic layer.

2. Description of the Related Art

In the manufacture of semiconductor device and integrated circuit, it is necessary to use a substance, generally referred as a photoresist (PR), for transferring a desired pattern onto the substrate by means of photolithography. During the patterning process, the selected area of the substrate coverd by photoresist is protected while the unprotected area of the substrate is attacked by etchant. After the patterning process, photoresist and the polymer residue, such as the polymer remained on the sidewall so called sidewall polymer fence, have to be removed from the semiconductor device thoroughly in order to obtain a completely clean surface which meets the high purity requirement of semiconductor technology.

However, there is no perfect stripper for efficiently removing PR and the polymer residue at a time. Some hardened polymer residue, such as the sidewall fence polymer, is cross-linked resulting from the dry etching process (O₂ plasma), and is very difficult to be removed by the PR stripper. Therefore, after the metallic layer has been patterned, PR is immediately removed from the patterned substrate by a PR stripper to avoid the metallic layer being contaminated by the polymer material. The polymer residue is then removed by a particularly strip solvent.

Generally, process of manufacturing semiconductor device can be divided into two major parts. The first half of the process, conducted before the metallic layer is patterned, is named ante metal process. The second half of the process, conducted after the metallic layer is patterned, is named post metal process. The polymer residue is removed during the post metal process. In the post metal process, the semiconductor device is immersed in the stripper bath and heated to a specific temperature (so called process temperature) for removing the polymer residue, as known in the art. The process temperature depends on the properties of stripper in use.

Conventionally, the stripper for removing the polymer residue is a chemical mixture containing hydroxylamine (HDA). For example, U.S Pat. No. 5,279,771 to Lee describes a non-aqueous stripping composition containing hydroxylamine, alkanolamine and an organic polar solvent. Another Lee reference, U.S Pat. No. 5,334,332 describes a cleaning solution for resist-free substrate containing hydroxylamine, alkanolamine and water.

Unfortunately, this key component in many photoresist strippers used in the manufacturing of semiconductors, HDA, has become worldwide shortage due to explosions at two HDA chemical suppliers within the past two years—Concept Sciences of Allentown, Pa., USA in February, 1999 and Nisshin Chemical of Japan in June, 2000. Many chip manufacturers have sought new non-HDA strippers to assure uninterrupted product supply.

“MR-10”, available from Mitsubishi Gas Chemical, is one of those developed chemicals, and has the great potential for replacing HDA due to the good capability of removing sidewall fence polymer. “MR-10” is composed of water, alkanolamine and a sugar alcohol, wherein the sugar alcohol acts as a corrosion inhibitor. The standard “MR-10” contains 15% of water, and is no harm to the metallic layer of the semiconductor device. However, the drawback of standard “MR-10” is that the lifetime of standard “MR-10” (water content of 15%) is too short, so that the strip process window of “MR-10” is narrow. The lifetime of “MR-10” means the overall working period of “MR-10” for efficiently cleaning the polymer residue. During the lifetime, the stripping capability of “MR-10” is decreased as the stripping progress, but the removing effect is still acceptable. After the lifetime, the old “MR-10” has to be drained away, and the reservoir is refilled with the entirely new “MR-10” to maintain the stripping capability in a fine level for effectively cleaning the polymer residues. Accordingly, “MR-10” with short lifetime will raise the primary cost in the manufacture of semiconductor device.

In accordance with the aforementioned description, it is the main concern for the manufacturers that how to extend the lifetime and broaden the process window of “MR-10” without causing damage, such as corrosion on metallic layer, to the semiconductor device.

### SUMMARY OF THE INVENTION

It is therefore an object of the invention to improve the water content of “MR-10” so that the lifetime of “MR-10” is greatly extended, and the polymer residue can be efficiently removed without corroding the metallic layer of the semiconductor device.

The invention achieves the above-identified objects by providing a “MR-10” composition with improved water content for efficiently removing a polymer residue on a substrate in post metal solvent strip process. The composition of the invention substantially comprises water, alkanolamine and a sugar alcohol, and the amount of water is about 20%. The lifetime of the composition is extended from 12 hours to 48 hours by increasing the amount of water from about 15% to about 20%. To remove the polymer residue, the composition of the invention is applied to a substrate for about 5 min to 15 min at a temperature ranged from about 60° C. to 70° C.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a graphical representation of the evaporation rate of the stripping solution of the invention.

### DETAILED DESCRIPTION OF THE INVENTION

“MR-10”, a non-hydroxylamine (HDA) solvent, is developed for replacing HDA due to its good capability of removing sidewall fence polymer. “MR-10”, available from Mitsubishi Gas Chemical, is composed of water, alkanolamine and a sugar alcohol, wherein the sugar alcohol acts as a corrosion inhibitor and the standard water content is 15%. It has been known that increase of water concentration enhances the polymer-removing capability of the alkanolamine type stripper (such as “MR-10”) as well as the corrosion of the metal surface. The water content of “MR-10” has to be chosen carefully in order to remove the polymer residue completely without attacking metal surface and the other parts of the semiconductor device. Accordingly, a series of experiments are conducted to investigate the water content effect on the performance of “MR-10”. The lifetime of improved “MR-10”, which the water content is increased from standard (15%) to an adequate value, is also greatly extended.

In the present invention, the stripping solution of “MR-10” is applied to the post metal process for removing the polymer residue. The water content of the invention is raised to about 20 %. The stripping processes of the invention are performed at two different temperatures of 60° C. and 70° C. The control experiments, which the stripping processes are performed at the temperature of about 60° C. and 70° C. by using standard “MR-10” with water content of 15%, are also conducted for comparison.

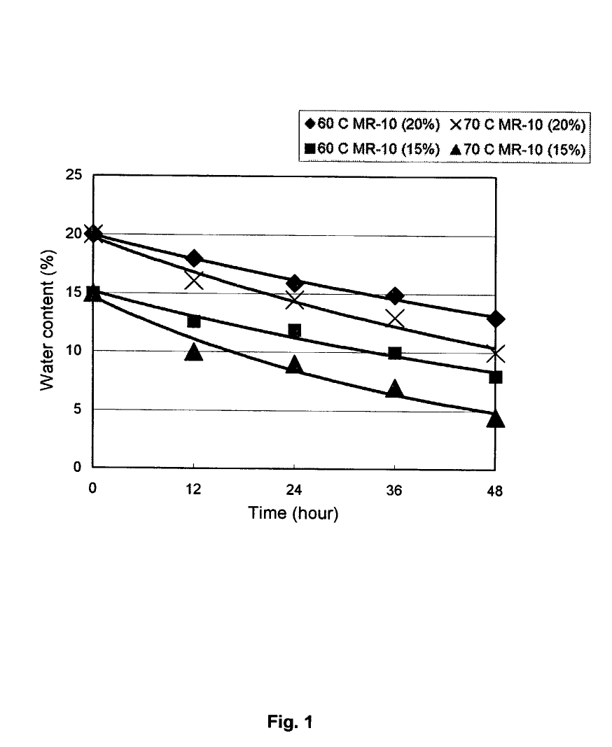

Since the stripping processes, immersed the semiconductor devices in the stripper bath, is under an open condition, the water content of the stripper, “MR-10”, is decreased by evaporation as the stripping progress. FIG. 1 is a graphical representation of the evaporation rate of the stripping solution of the invention. The horizontal ordinate represents the experimental time of forty-eight hours, and the vertical ordinate represents the water content of the stripper, “MR-10”. Each data point in FIG. 1 presents instantaneous water content of each “MR-10” under a constant process temperature. At the process temperature of 60° C., the water content of “MR-10” of the invention is dropped from original 20% to about 13 % after 48 hours (curve symbolized by legend ♦) while the water content of “MR-10” of control experiment is dropped from original 15% to about 8% after 48 hours (curve symbolized by legend ▪). At the process temperature of 70° C., the water content of “MR-10” of the invention is dropped from original 20% to about 10% after 48 hours (curve symbolized by legend x) while the water content of “MR-10” of control experiment is dropped from original 15% to about 5% after 48 hours (curve symbolized by legend ▴).

Also, the semiconductor device is immersed in the stripper bath containing 48-hour-old “MR-10” for 15 min at the temperature of 70° C., and then further inspected under a scanning electron microscopy (SEM). The SEM results (not shown) indicate that some of the polymer residue still remains on the sidewall when the stripping solution of “MR-10” originally containing 15% water is 48 hours old, but the polymer residue is completely removed when “MR-10” originally containing 20% water is 48 hours old. Those results implicate that instantaneous water content of “MR-10” has to be larger than 5%, and 10% can ensure the polymer residue is completely removed. At the process temperature of 70° C., since “MR-10” of the invention (originally containing 20% of water) still can completely remove the polymer residue when it is the 48-hour-old, the “MR-10” lifetime of the invention is certainly prolonged to at least 48 hours.

A series of experiments are conducted to investigate the effect on the immersion time of devices at different age of “MR-10”. The procedures and results are presented in the following examples. However, those examples are intended to illustrate the invention more clearly, and are not intended to limit the scope of the invention.

### EXAMPLE 1

“MR-10” originally containing water of 20% is prepared as the stripping solution of the invention. The stripper bath is heated to a temperature of about 60° C. for proceeding the stripping process. The processes are conducted in the beginning and every 12 hours within 48 hours. At each time, the semiconductor devices having the to-be-removed polymer residue are individually immersed in the “MR-10” bath for 5 min, 15 min, 30 min, and 60 min.

After the stripping process, the devices are observed under a scanning electron microscopy (SEM) to examine if the polymer residue is completely removed. Since the increase of water content of “MR-10” will enhance the capability of attacking the metallic layer, the metallic layer, such as aluminum or aluminum alloys, titanium nitride, titanium tungsten and the like particularly corrosion sensitive, is also examined to observe the corrosion condition. The results are summarized in Table 1.

In Table 1, process time means that the immersion time of semiconductor device, and retention time means that the accumulated hours of “MR-10” staying in the stripper reservoir. Additionally, two symbols in a cell of Table 1 express the results of each test. The first symbol represents the condition of polymer residue removal, and the second symbol represents the condition of corrosion of metallic layer. The following legends are used to indicate the capability of polymer residue removal and anti-corrosion performance of “MR-10”.

O: the case where the polymer residue is completely removed from the sidewall, and the case where none of the sides or surface of the metallic layer is corroded;

Δ: the case where the polymer residue is mostly removed from the sidewall, and the case where the metallic layer is partially corroded; and

X: the case where most of the polymer residue is remained on the sidewall, and the case where the metallic layer is seriously corroded.

According to the results of Example 1, it significantly indicates that the lifetime of “MR-10” with original water content of 20% has been extended to 48 hours at the temperature of 60° C., and the adequate process time (immersion time) is about 15 min. The immersion time of 5 min is too short to completely remove the polymer residue since the polymer-removing capability of “MR-10” is a little bit weakened after 48 hours. However, if the process time is about 30 min or 60 min, the contact period of the semiconductor device and the stripper “MR-10” is too long that corrosion of the metallic layer is occurred although the polymer residue is completely stripped.

### EXAMPLE 2 (COMPARATIVE)

A control experiment is conducted in Example 2 in comparison with Example 1. In Example 2, the process temperature is about 60° C. and the procedure is repeated except that the original water content of “MR-10” is 15%. After the stripping process, the semiconductor device is also inspected under a scanning electron microscopy (SEM) to examine if any polymer residue remains on the device and any corrosion occurs on the metallic layer. The results are summarized in Table 1.

The results of Example 2 apparently shows that the lifetime of “MR-10” with original water content of 15% (Example 2) is only 24 hours, and the immersion time (process time) is 15 min or 30 min correspondingly. When the immersion time is 5 min, only unused “MR-10” possesses the good polymer-removing capability. The polymer-removing capability of “MR-10” is decreased with the increase of retention time. When the immersion time is prolonged to about 60 min, the corrosion of the metallic layer occurs although the polymer residue is completely stripped.

Compare the results of Examples 1 and 2, it proves that the increase of the original water content of “MR-10” does extend the lifetime significantly and widen the window process. At the process temperature of about 60° C., the lifetime of “MR-10” is greatly improved from 24 hours to 48 hours when the water content of “MR-10” is increased from 15% to 20%. The optimal process time, for the semiconductor device immersed in “MR-10” of 20% water at 60° C., is about 15 min.

### EXAMPLE 3

The procedure of Example 3 is the same as Example 1 except that the stripper bath is heated to about 70° C. At the process temperature of about 70° C., the semiconductor device is immersed in the “MR-10” bath with original water content of 20% for 5 min, 15 min, 30 min, or 60 min. These tests are conducted when the retention time of “MR-10” is 0 (unused stripper solution), 12, 24, 36, and 48 hours. The results are summarized in Table 1.

According to the results of Example 3, it significantly indicates that the lifetime of “MR-10” with original water content of 20% is extended to 48 hours, and the adequate process time (immersion time) is alternative 5 min and 15 min. When the immersion time is prolonged to about 30 min or 60 min, the corrosion of the metallic layer occurs except that the stripping process is carried out at the 48th hour of retention time. The reason for this situation is that the polymer-removing capability is a little bit weakened after 48 hours, and the semiconductor device is not corroded even the immersion time is up to 30 min.

Additionally, the results of Examples 3 and 1 comparably indicate that the stripping process proceeding at the temperature of about 70° C. has the better performance than at about 60° C. For example, while the immersion time is 5 min, “MR-10” at 70° C. is able to completely remove the polymer residue without corroding the metallic layer after 48 hours, but “MR-10” at 60° C. is not. However, when the immersion time is 15 min, the same effect is achieved in both cases.

### EXAMPLE 4 (COMPARATIVE)

A control experiment is conducted in Example 4 in comparison with Example 3. In Example 4, the process temperature is about 70° C. and the procedure is repeated except that the original water content of “MR-10” is 15%. After the stripping process, the semiconductor device is also inspected under a scanning electron microscopy (SEM) to examine if any polymer residue remains on the device and any corrosion occurs on the metallic layer. The results are summarized in Table 1.

The results of Example 4 shows that the lifetime of “MR-10” with original water content of 15% is only 12 hours while the process time (immersion time) is 5 min or 15 min. After 12 hours, the water of “MR-10” is evaporated and decreased to the amounts less than 10%, as shown in FIG. 1. The polymer-removing capability is consequently decreased so that most of polymer residue is still remained on the semiconductor device. Because the longer immersion time results in the less polymer residue, the lifetime of “MR-10” is extended 36 hours when the immersion time is about 30 min. If the immersion time is up to about 60 min, the corrosion of the metallic layer will occur in the first 24 hours.

However, the performance of “MR-10” turns out to be good after 36 hours and 48 hours. The reason is that the less water content of “MR-10” after 36 hours causes the minor injure of the metallic layer, and the immersion time of 60 min is long enough to remove the polymer residue completely.

Compare the results of Examples 3 and 4, it significantly indicates that the increase of the original water content does extend the lifetime of “MR-10” and widen the window process. At the process temperature of about 70° C. and the immersion time of about 5 min or 15 min, the lifetime of “MR-10” is greatly extended from 12 hours to 48 hours when the water content of “MR-10” is increased from 15% to 20%.

TABLE 1
Performance of “MR-10” (15% and 20% of water content)

Process time

| | | | | |
|---|---|---|---|---|
| Retention time (hr) | 5 min | 15 min | 30 min | 60 min |

Example 1: (Process Temperature 60° C., Water content 20%)

| | | | | |
|---|---|---|---|---|
| 0 | ◯/◯ | ◯/◯ | ◯/Δ | ◯/X |
| 12 | ◯/◯ | ◯/◯ | ◯/Δ | ◯/X |
| 24 | ◯/◯ | ◯/◯ | ◯/Δ | ◯/X |
| 36 | ◯/◯ | ◯/◯ | ◯/Δ | ◯/X |
| 48 | Δ/◯ | ◯/◯ | ◯/Δ | ◯/Δ |

Example 2: (Process Temperature 60° C., Water content 15%)

| | | | | |
|---|---|---|---|---|
| 0 | ◯/◯ | ◯/◯ | ◯/◯ | ◯/X |
| 12 | A/0 | ◯/◯ | ◯/◯ | ◯/X |
| 24 | A/0 | ◯/◯ | ◯/◯ | ◯/Δ |
| 36 | X/◯ | Δ/◯ | Δ/◯ | ◯/Δ |
| 48 | X/◯ | X/◯ | Δ/◯ | ◯/◯ |

Example 3: (Process Temperature 70° C., Water content 20%)

| | | | | |
|---|---|---|---|---|
| 0 | ◯/◯ | ◯/◯ | ◯/Δ | ◯/X |
| 12 | ◯/◯ | ◯/◯ | ◯/Δ | ◯/X |
| 24 | ◯/◯ | ◯/◯ | ◯/Δ | ◯/X |
| 36 | ◯/◯ | ◯/◯ | ◯/Δ | ◯/X |
| 48 | ◯/◯ | ◯/◯ | ◯/◯ | ◯/X |

Example 4: (Process Temperature, Water content 15%)

| | | | | |
|---|---|---|---|---|
| 0 | ◯/◯ | ◯/◯ | ◯/◯ | ◯/X |
| 12 | ◯/◯ | ◯/◯ | ◯/◯ | ◯/Δ |
| 24 | X/◯ | Δ/◯ | ◯/◯ | ◯/Δ |
| 36 | X/◯ | X/◯ | Δ/◯ | ◯/◯ |
| 48 | X/◯ | X/◯ | Δ/◯ | ◯/◯ |

Note: Removal/corrosion,
◯: very good, Δ: good, X: bad.

The above examples clear shows that increase of the water content of “MR-10” does extend the lifetime of “MR-10”. By increasing water content from 15% to 20%, the lifetime of “MR-10” is efficiently extended from 12 hours to 48 hours. Additionally, an optimizing process window is found at the process temperature of about 70° C.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A composition applied to remove a polymer residue on a substrate in post metal solvent strip process substantially comprising water, alkanolamine and a sugar alcohol, the improvement comprising:
increasing the amount of water to about 20%, and applying the composition for about 5 min to 15 min at a temperature ranged from about 60° C. to 70° C.

2. The composition according claim 1, wherein the composition is preferably applied at a temperature of about 70° C. for removing the polymer residue.

3. The composition according claim 1, wherein a lifetime of the composition is about 36 hours when the composition is applied for about 5 min at a temperature of about 60° C.

4. The composition according claim 1, wherein a lifetime of the composition is about 48 hours when the composition is applied for about 15 min at a temperature of about 60° C.

5. The composition according claim 1, wherein a lifetime of the composition is about 48 hours when the composition is applied for a period ranged from about 5 min to 15 min at a temperature of about 70° C.

6. The composition according claim 1, wherein the polymer residue is a sidewall polymer fence.

7. A method of removing a polymer residue from a substrate comprising the step of contacting the substrate having the polymer residue with a non-HDA cleaning composition substantially comprising water, alkanolamine and a sugar alcohol, wherein the improvement comprises:
increasing the amount of water to about 20%; and
contacting the substrate with the composition for about 5 min to 15 min at a temperature ranged from about 60° C. to 70° C.

8. The method of removing a polymer residue according to claim 7, wherein the substrate is contacted with the composition at a temperature of about 70° C. for removing the polymer residue.

9. The method of removing a polymer residue according to claim 7, wherein the polymer residue is a sidewall polymer fence.
